(19) United States
(12) Patent Application Publication
(10) Pub. No.: US 2013/0204776 A1
(43) Pub. Date: Aug. 8, 2013

(54) E-commerce Payment and Delivery System and Method

(71) Applicant: F. Charles King, West Chicago, IL (US)

(72) Inventor: F. Charles King, West Chicago, IL (US)

(21) Appl. No.: 13/527,029

(22) Filed: Jun. 19, 2012

Related U.S. Application Data
(60) Provisional application No. 61/596,464, filed on Feb. 8, 2012.

(51) Int. Cl. G06Q 20/10; G06Q 10/08; G06Q 30/06

(52) U.S. Cl. 705/39

(57) ABSTRACT

An e-commerce payment and delivery system comprising a combination of electronic components, proprietary software, banking services and a cartage company. Buyer and seller fill out a registration form and create their own electronic accounts on the web portal via their own personal computer or a kiosk. When the buyer finds something he/she wishes to buy, the buyer accesses his/her account and creates a transaction record, with the pertinent sale information, and sends the transaction record to the seller. The seller verifies that the transaction record is accurate and the buyer must fund his/her own account. The buyer's deposit is transferred from the buyer's account into an electronic bank accessible to the cartage vendor. The seller presents the goods and transaction card to the cartage vendor and the teller processes the goods for shipping, verifying that the goods being shipped are the goods buyer ordered.

### BACKGROUND OF THE INVENTION

1. Field of the Invention

The present invention relates to electronic commerce and, more particularly, to systems and methods to facilitate safer long distance e-commerce transactions, integrating payment and shipping.

2. Description of the Prior Art

Consumers today increasingly purchase goods and services through the internet and conduct financial transactions through e-commerce. The impersonal nature of e-commerce increases the chances of fraud on the buyer in that the buyer is not given the opportunity to inspect and test the goods before paying for them. The buyer runs the risk that the goods shipped are not as they appear to be on the computer screen, that the goods are not what were ordered, or that the goods were not shipped at all. Most buyers won't risk private long-distance transactions when pre-payment is required.

U.S. Pat. Nos. 7,499,886, 7,451,114, and 7,921,038 each disclose a method for conducting electronic commerce between individuals. Receiving payment includes the establishment, at a first server, of a transaction record including information identifying payment amount, a first account to be credited by the payment amount, and a second account to be debited by a debit amount. If an authorization analysis of at least the second account is successfully completed, the second account is debited and the first account is directly credited by the payment amount to conclude the transaction. Risk analysis of each individual may be performed and payment may be held in escrow to allow the buyer to receive and inspect the goods. None of these patents disclose a method that ensures that the goods shipped are the same as the goods purchased, before money exchanges hands.

U.S. Pat. No. 7,899,716 discloses a system and method for integrated payment and shipping information. The system consists of a product distribution module integrated with a payment module. Clicking a “buy” button triggers the creation of a product mailer for a seller, and triggers the payment module to collect and hold the purchase price and shipping costs from the buyer. Acceptance of delivery by the buyer, or the expiration of a time-out period after tracking delivery by the distribution module, triggers release of the purchase price to the seller. If the buyer objects to the product, at the buyer's discretion the product can be returned, but the buyer is required to pay a portion of the return shipping costs. Although patent '716 discloses a method for return of unsatisfactory products, the method does not ensure the shipment of satisfactory products before payment is rendered.

U.S. Pat. No. 7,908,226 discloses a method and apparatus for ordering goods, services and content over an internetwork using a virtual payment account. The virtual payment system comprises a commerce gateway component and a credit processing server component. Buyers and sellers must both become a registered participant by applying for a virtual payment account. The buyer's virtual payment account is assigned a credit limit. The buyer can order a product from a seller and charge it to the virtual payment account. When the product is shipped, the seller notifies the commerce gateway component, which in turn notifies the credit processing server that applies the charges to the buyer's virtual payment account. The buyer can then settle the charges using a prepaid account, a credit account, or by using reward points earned through the use of the virtual payment card. Patent '226 does not disclose a method which ensures that the goods shipped are the same as the goods purchased, before money exchanges hands.

The prior art to date does not disclose a method in which the buyer and seller can create accounts and transfer money only upon shipment of satisfactory goods. None of the prior art can be combined in this way to suggest these necessary modifications. There is no teaching, suggestion, or motivation that would have enabled a person of ordinary skill in the art to modify any prior art system to incorporate verification of product satisfaction upon presentment to a shipping vendor in order to actuate payment.

A primary object of the present invention is to reduce the risk of fraud and ensure that the transaction is secure and that the buyer receives satisfactory goods, by verifying the goods, taking a picture of the seller, and providing a legal recourse.

It is another object of the present invention to facilitate private, long distance transactions between two private individuals.

It is a further object of the present invention to reduce the time delay of sending funds in an envelope to the seller and, in turn, receiving goods from the seller.

### SUMMARY OF THE INVENTION

The e-commerce payment and delivery system and method of the present invention comprises a combination of electronic components, proprietary software, banking services and cartage companies. The buyer and seller can access the system via their own personal computer or a kiosk. Once on the web portal, the buyer and, optionally, the seller fill out a registration form and create their own electronic accounts. When the buyer finds something he/she wishes to buy, the buyer accesses his/her account and creates a transaction record, with the pertinent sale information, and sends the transaction record to the seller. The seller verifies that the transaction record is accurate and the buyer must fund his/her own account. The buyer's deposit is transferred from the buyer's account into an electronic bank accessible to the cartage vendor when the terms have been met at a point of delivery for shipping. The seller presents the goods and transaction card to the cartage vendor and the teller at the cartage vendor location processes the goods for shipping, verifying that the goods being shipped are the goods buyer ordered. The teller enters tracking information into the transaction record stored in the system and shows the seller the screen displaying the purchase price, shipping costs, service fees, and tracking numbers. The seller verifies the accuracy of the information, and the database releases the funds from the electronic bank to the seller.

### BRIEF DESCRIPTION OF THE DRAWINGS

The systems, methods, and computer readable media for controlling display objects in accordance with this specification are further described with reference to the accompanying drawings in which:

FIG. 1 depicts a flow diagram of a general overview of an illustrated embodiment of the system and method of the present invention.

FIG. 2-1 depicts a flow diagram of the buying/selling process of an illustrated embodiment of the system and method of the present invention.

FIG. 2-2 depicts a flow diagram of the seller using a pick-up delivery system from home for shipment in an alternate embodiment of the system and method of the present in

FIG. 3 depicts a flow diagram of one cycle of use of an illustrated embodiment of an e-commerce payment and delivery system and method of the present invention.

### DETAILED DESCRIPTION OF THE ILLUSTRATED EMBODIMENTS

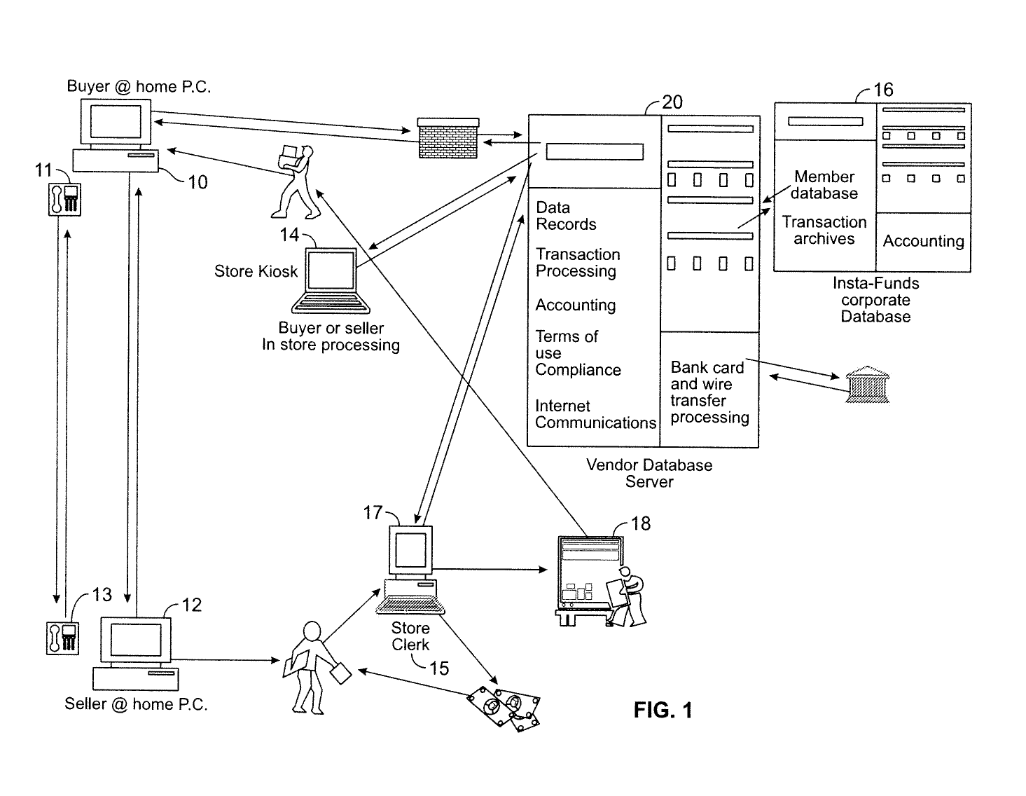

FIG. 1 depicts a flow diagram of a general overview of an illustrated embodiment of an e-commerce payment and delivery system and method according to the present invention. The system primarily comprises a shipping vendor location 14, a shipping vendor database and server 20, and a corporate database and server 16. A buyer and seller communicate with the system either via their home PC 10/12, their home/office PC directly connected to nationwide shipping via internet, or via a vendor kiosk 14. The buyer and seller also communicate with each other via their home PC 10/12 or via the telephone 11/13. The shipping vendor database and server 20 processes and stores data records, transaction records, accounting, terms of use compliance, internet communications, and third party bank cards. The corporate database and server 16 processes and stores member records, transaction archives, and accounting. Transactions of payment and shipping are completed using the internet and are routed through the shipping vendor server 20.

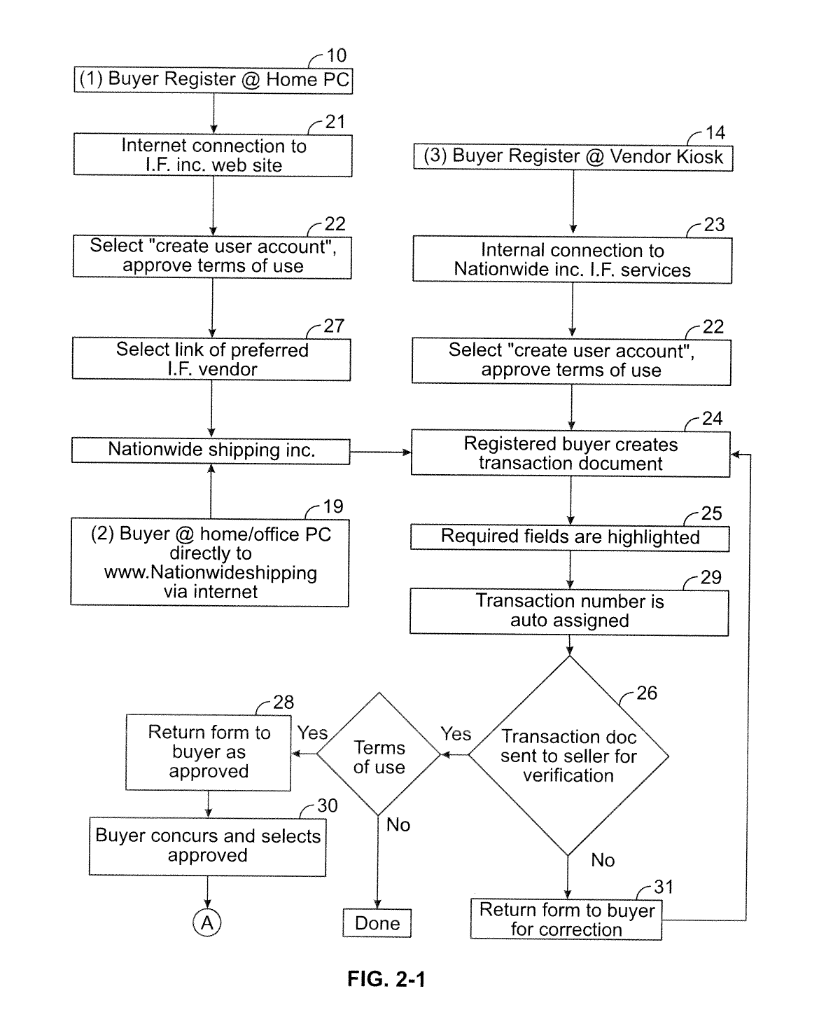

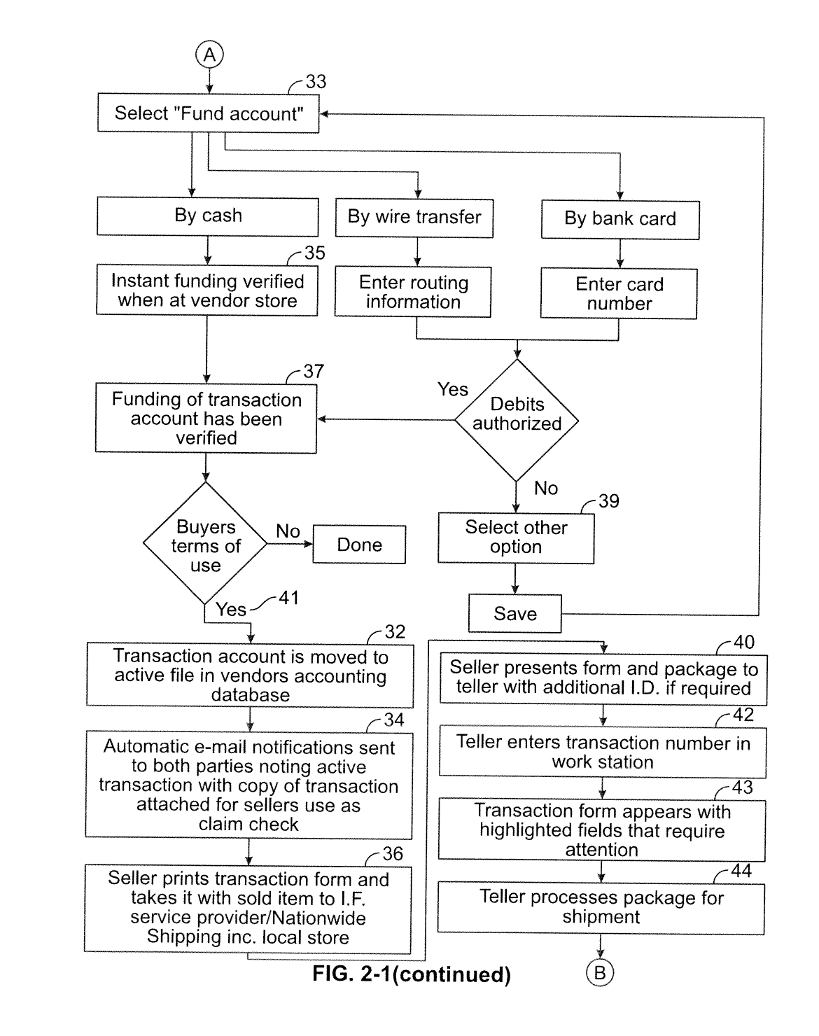

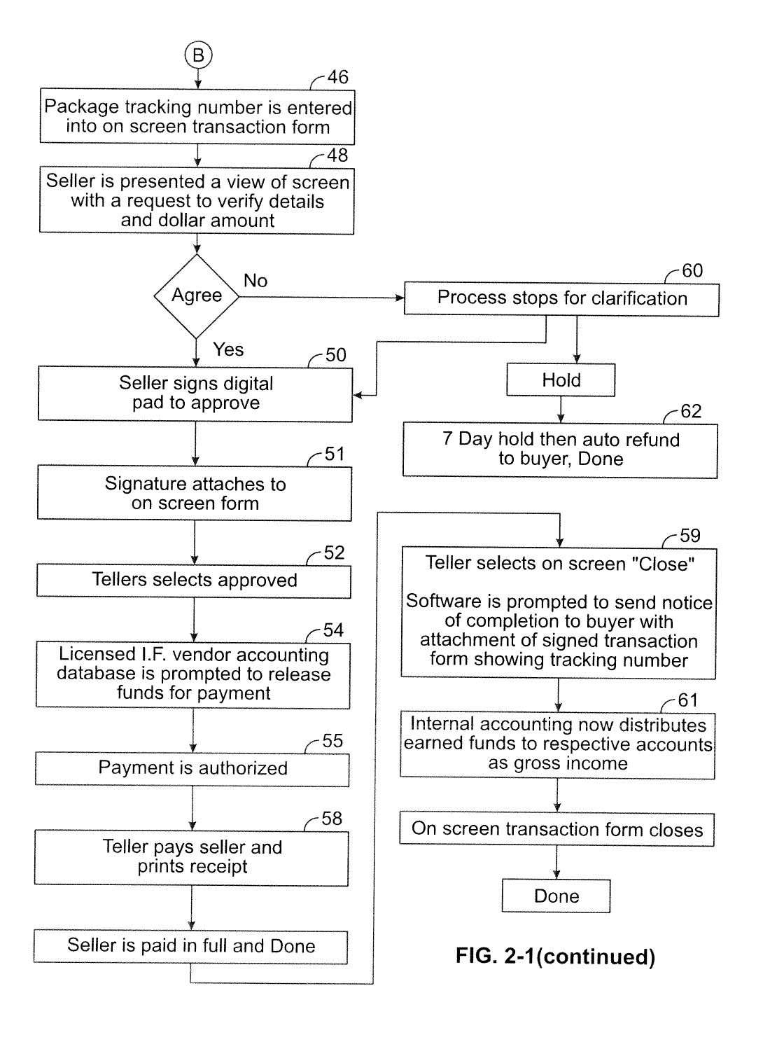

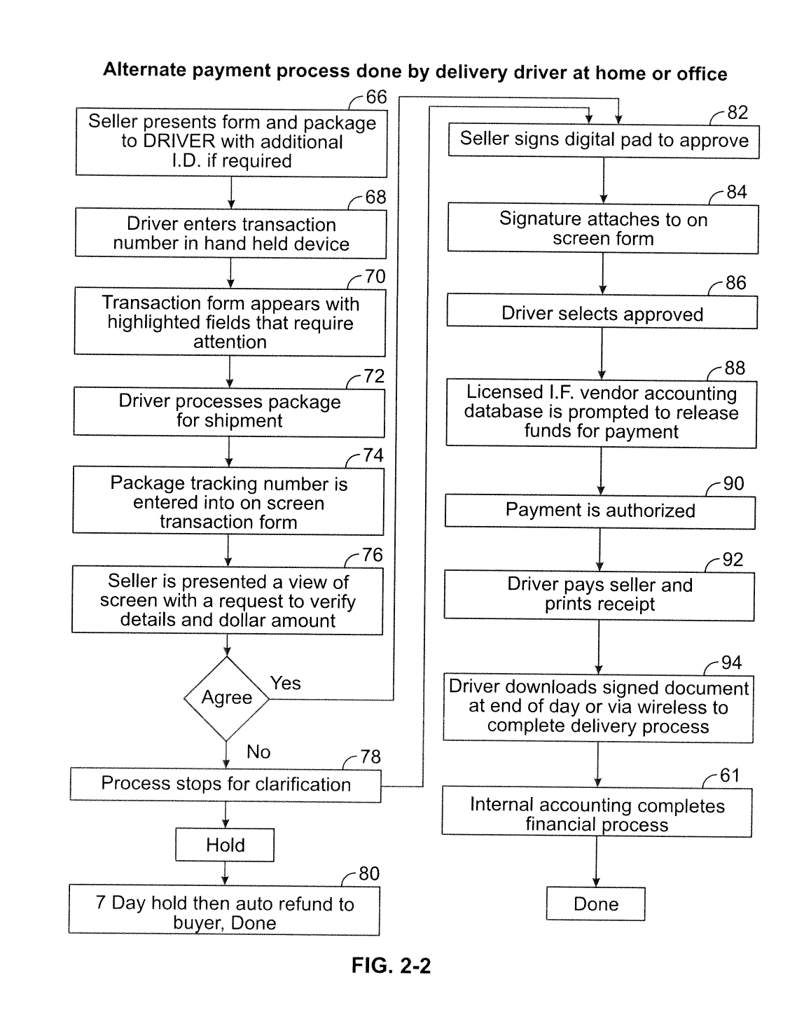

FIG. 2-1 depicts a flow diagram of the buying/selling process of an illustrated embodiment of an e-commerce payment and delivery system and method. A buyer must have an account with the e-commerce payment and delivery system and method in order to use the system. If the buyer has previously registered an account, that information would be saved to the corporate database 16. Account information can be retrieved from the corporate database 16 simply by buyer logging into his/her account. If buyer does not have an account, buyer must access the corporate website at a home PC 10/12 with an internet connection to the corporate website 21, a home/office PC directly connected to nationwide shipping via internet 19, or at a vendor kiosk 14 with an internal connection to nationwide corporate services 23 and selects“create a user account” 22. Buyer fills in registration information which requires at least name, address, e-mail address, phone number, security question and password. Bank card, account information, and an identification picture are optional and can be submitted on the registration form. When buyer clicks the submit button, the software scans the application for errors or missing information and highlights all missing fields. If all information is correct, the button for “Read Terms of Use” appears and buyer/seller must click the “I Agree” button. A member number, consisting of a numerical prefix, two letters identifying their state of residence, and their zip code, is assigned and all information is stored in the corporate database 16. Buyer/seller is sent a confirmation e-mail, which must be responded to, to complete registration. Registration information is updated automatically each year.

Buyer, a registered user, must create a transaction record 24 in order to complete a purchase. From a store kiosk 14, Buyer would select “Create Transaction” 24, enter her password, and click “Enter.” A transaction form appears and the required fields are highlighted 25. From a home PC 10 (FIG. 1), Buyer accesses the corporate database 16 and selects the shipping vendor 27 of their choice. By selecting the payment and shipping service link on the provider webpage, a number of selections become available, such as “About,” “Register,” “Create Transaction,” and “Terms of Use.” Buyer selects “Create Transaction” 24, enters her password, and clicks the “Enter” button and the transaction form appears with the required fields highlighted 25. From a home/office PC 19, the buyer directly connects to nationwide shipping via the internet and creates the transaction record 24 from there. A transaction form appears and the required fields are highlighted 25. A transaction number is automatically assigned 29.

When the transaction form opens on the screen, the required personal information of the buyer is automatically filled from the buyer's stored, registered account, which includes buyer's name, address, phone number, e-mail address, and zip code. The buyer will need to fill in the seller's required personal information, which was collected when the terms of the sale and shipping were concluded between the buyer and seller, and includes seller's name, address, phone number, e-mail address, and zip code.

Accounting fields will include, but are not limited to, option fees charged, service fees charged, shipping fees charged, total fees charged, and sale price paid to seller. Security features may also be implemented, such as requiring a photo I.D. and matching the photo with an uploaded facial photo. The transaction record may include a picture of the seller and/or of the purchased item. Insurance, money back guarantee, pick-up package service and other options may be added per vendor preferences.

The “Estimate Shipping Costs” button on the transaction form links the form to the shipper's cost calculator. The size and weight of package agreement made between the buyer and seller is used for the estimate. The shipping cost field is automatically filled from the package shipper's cost estimator. The “Estimate” changes to “Actual Shipping Costs” when the item is processed at the point of shipment at the shipping vendor's location. During the selection of options and entering of currency data in the transaction form, totals are being calculated and changed in real time. This enables the buyer to see costs as they add up when selecting “optional services.”

The “Exit” button prompts the user to “Save?” the form. If user clicks “Yes,” the form is saved for seven days. If user clicks “No,” the form is then deleted. The “Next” button is used after all required information and optional information has been entered. This prompts the software to review the form. Any incorrect or missing information fields will be highlighted for attention. If all information is correct, the “Terms of Use” page with legal text appears. The user can either select “Yes, I Agree” or select “No.” If “No” is selected, the page returns to the “Create Transaction” page 24 and prompts the user to “Save transaction form?” with “Yes” and “No” buttons. If Yes, “I agree to terms” is selected and the completed transaction form returns on screen and the “Confirm with Seller” button appears.

The “Confirm with Seller” button prompts the software to generate an automatic e-mail to the seller's e-mail address with a notice of transaction, and sends the transaction record to the seller 26. The transaction document is sent to the seller for verification 26. If the transaction document is not accurate it is returned to the buyer 31 for correction. Seller reviews the transaction record and if not satisfied, the seller selects the “Reject” button. This action opens a window on the transaction form for seller to enter text to explain the reason for the rejection. After entering text, the seller selects the “Send” button. The “Send” button is an automatic e-mail link back to the vendor database 20, which forwards the “rejected” transaction form to the buyer for adjustment and resubmission. If all the information is correct, per the deal made over previous private communications between buyer and seller, seller returns the e-mail to the buyer as approved 28 by selecting “Approve Transaction.” Clicking the “Approved Transaction” button will prompt the software to open “Terms of Use” and “I Agree” with “Yes” and “No” buttons. If seller clicks the “No” button, the page reverts back to the transaction form where seller can “Reject” and type reasons for the rejection into a text box. If seller clicks the “Yes” button, the page returns to the transaction form. The form will now show that the seller approves all terms of the transaction. The selection of “Yes” will also automatically return the approved transaction form to the buyer via the shipping vendor's database 20 and move the transaction record to the active file database 32. Buyer then concurs and also approves the transaction document 30. The “Cancel” button will cancel the transaction and return an e-mail with notice of cancellation through the database to the buyer.

The approved transaction is returned to the buyer and the “Fund Transaction” button is then functional. The buyer must then select “Fund Account” 33 and can select the type of input funds, such as cash, wire transfer, or bank card, and the type of output funds, such as cash, credit, bank card, wired to account, or money order. Funding the account by cash allows for instant funding verified when the seller is at the vendor store 35. Funding the account by a wire transfer, the buyer must enter routing information. Funding the account by bank card, the buyer must enter the card number. If the debits are not authorized, the buyer must select another method of funding 39. If the debits are authorized, or the cash has been deposited, the funding of the transaction account has been verified 37. Once the buyer agrees to the terms of use 41, the transaction account is moved to the active file 32 in the shipping vendor's accounting database.

If “Fund account by cash” is selected, then cash will need to be paid at a participating shipping vendor store. Optional instant funding may be done from an in-house cash holding account. After the crediting of the account, the form will show “Fully Funded” and a receipt for cash will be given to the buyer by the teller 15. If the funding of the account is made with a bank card, wire transfer, check, money order, certified funds, or by a method other than cash, the system will proceed with proper routing as necessary. Account will not show “Fully Funded” until funds have been verified to be credited to the account. When confirmed as fully funded, the “Send” button is activated and the transaction is now ready for activation. Selection of the “Send” button starts the delivery process. A copy is stored in the corporate database 16 and the shipping vendor's database 20 for store clerks or tellers 15 to use, and an active transaction alert, noting a fully funded transaction, is automatically sent to both parties (buyer/seller) noting an active transaction 34, with a copy of the transaction attached for the seller to use as a claim check. Clicking the “Cancel” button prompts the “Save” or “Delete” button options.

The seller opens the e-mail sent to him/her to find a note with an attachment of a fully funded transaction agreement form. This transaction form is printed 36 and used as a claim check to, in part, identify the seller and to aid in processing the shipment and payment. The seller takes it with the sold item to a corporate service provider or a nationwide shipping local store. Alternatively, the seller can write down the transaction number in order to present it to a service vendor teller 15.

The seller then takes the transaction record, or transaction number, and the sold item to a participating shipping vendor store location 38 of his choice, such as the U.S. Postal Service, Federal Express, UPS, or DHL. Upon arrival at the shipping vendor store, the seller presents the transaction record and item for shipping 40, with additional I.D. if required. The teller 15 scans or enters the transaction number manually 42 into the work station computer and retrieves the account to read the processing instructions and identification requirement details. The transaction form appears with highlighted fields that require attention 43. After processing the item for shipment 44, the teller 15 enters the shipment tracking information into the transaction record on-screen 46. Shipping costs are automatically calculated and confirmed by the software and the “estimated” shipping cost is changed to “actual” shipping cost in the record. Any changes in shipping costs are to be paid by the seller, based on pre-determined size and weight estimates between the buyer and seller. The teller 15 shows the seller the transaction record screen 48, with a dollar total for goods, shipping costs, and service fees. If the transaction record is not verified by the seller, the process stops for clarification 60. A hold is placed on the record and, if the transaction record is not verified within seven days, the funds are returned to the buyer 62. If seller verifies the transaction 48, seller signs the digital pad, which attaches to the on-screen transaction record and selects “I Accept” to approve the transaction 50. Teller 15 selects approved 52, and the licensed shipping vendor accounting database 20 is prompted to release funds 54 for payment. The selection of “I Accept” prompts the system to authorize the payment 55 in the form agreed to in the transaction agreement and adds the signature to the transaction record. The shipping vendor database 20 checks that the required information is present 56 and, if it is, it releases the funds to the seller. If the required information is not present, the missing fields are highlighted 64 and teller 15 must enter the missing information. Teller 15 pays the seller and prints a receipt 58.

When the teller 15 selects the “Close” button, the software is prompted to send notice of completion to the buyer with attachment of a signed transaction form showing tracking number 59. A copy is also sent to the seller's e-mail address and to the corporate database 16. Internal accounting then distributes earned funds to the respective accounts as gross income. The on-screen transaction form closes.

Alternatively, shown in FIG. 2-2, the seller can arrange for pickup service with a participating shipping vendor. The pickup service personnel will have a hand-held device to process payment and shipping of the item. The seller presents the transaction form and package to the driver, with additional I.D. if required 66. The driver enters the transaction number into the hand-held device 68 and the transaction form appears with highlighted fields that require attention 70. The driver processes the package for shipment 72 and enters the package tracking number into the on-screen transaction form 74. The seller is presented with a view of the screen to verify the details and dollar amount 76. If the transaction record is not verified by the seller, the process stops for clarification 78. A hold is placed on the record and, if the transaction record is not verified within seven days, the funds are returned to the buyer/seller 80. If seller verifies the transaction and signs the digital pad 82, the signature attaches to the on-screen transaction record 84 to show seller's approval. The driver selects approved 86 and the licensed shipping vendor accounting database 20 is prompted to release funds for payment 88. Once the payment is authorized 90, the driver pays the seller and prints a receipt 92. The driver downloads the signed document 94 when he/she returns to the shipping vendor location at the end of the day or downloads the signed document 94 via a wireless connection at the moment to complete the delivery process. Internal accounting completes the financial process.

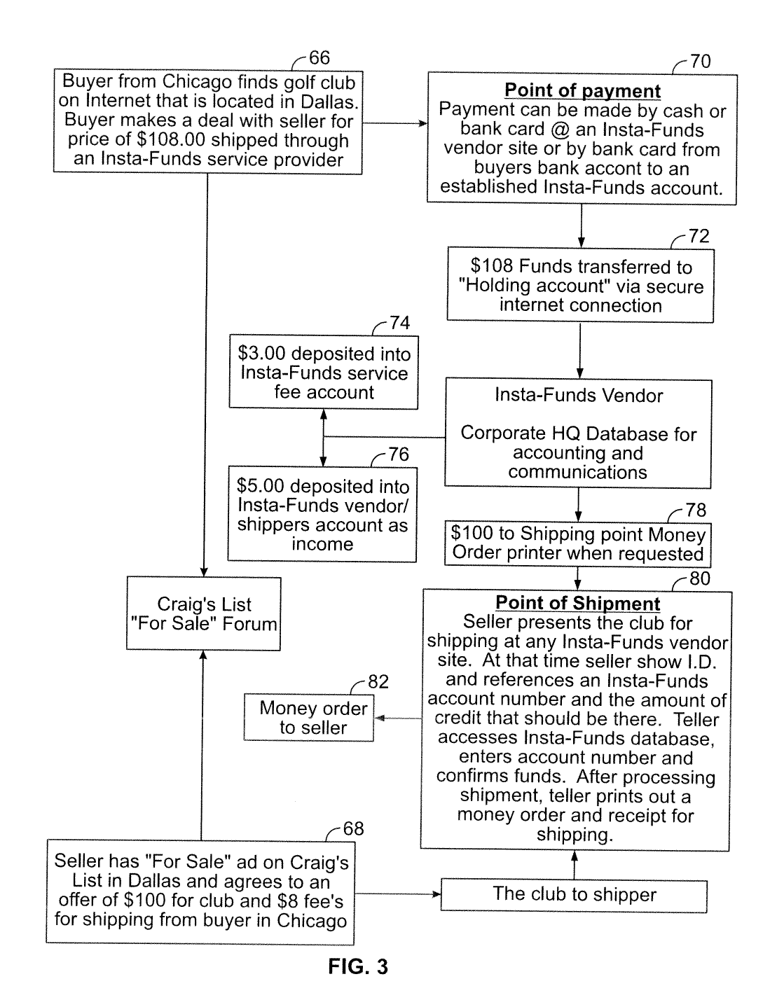

FIG. 3 depicts a general overview of one cycle of use of an illustrated embodiment of an e-commerce payment and delivery system and method. Seller, who lives in Dallas, has a golf club that he wants to sell. He posts 68 a “For Sale” ad on www.craigslist.com to which buyer finds and makes an inquiry 66. Buyer makes an offer of $108, $100 for the golf club and an additional $8 for shipping costs and fees, and seller accepts 68. Buyer registers with the corporate database 16 (FIG. 1) and creates a transaction record. Buyer must fund the transaction 70 with cash or credit at a participating shipping vendor's location 17 or by credit card from his home or office PC 10. Buyer can also fund the transaction 70 by direct wire transfer from buyer's bank account to his established corporate account. The agreed upon price, $108 for the golf club and shipping costs and fees, is transferred 72 to thecorporate electronic bank. Once transferred to the electronic bank, $3 is transferred to the service fee account 74, $5 is transferred into the shipping vendor's account 76, and $100 remains in the electronic bank to pay seller, which, when requested, is transferred through an internal accounting process to the shipping vendor location's 17 money order printer 78.

Seller takes the golf club and presents it for shipping 40 (FIG. 2) at any selected shipping vendor location 17. The seller shows ID, the transaction number, and transaction details, such as purchase price, to store teller 15. The store teller 15 accesses the shipping vendor's database 20, enters the transaction number 42, and confirms that funds are available in the account. After teller 15 has processed shipment 44 of the golf club, teller 15 prints out a money order 78 and receipt for shipping 80, and presents 82 the money order and shipping receipt to the seller. The method for the e-commerce payment and delivery systemdescribed can be stored on a computer readable medium as computer executable instructions. The method runs on a system comprising a computing device and a display. The computing device executes the computer executable instructions contained in the computer readable medium, and the display displays the graphic image generated by the method of the present invention.

The foregoing description of an illustrated embodiment of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

What is claimed is:

1. A method for electronic payment and delivery of goods, the method comprising:
a. registering an account of a first individual on a server and creating a transaction record with information associated with a transaction between the first individual and a second individual;
b. depositing funds in the first individual's account;
c. transferring the deposit from the first individual's account into an electronic bank;
d. approving the transaction record by both the first and second individuals;
e. presenting the second individual's goods to a shipping vendor;
f. entering a tracking number into the transaction record;
g. shipping the goods to the first individual using the shipping vendor; and
h. transferring the deposit from the electronic bank to the second individual.

2. The method of claim 1, wherein the first individual makes the deposit selected from the group consisting of the steps of using a bank card, credit card, wire transfer, and using cash.

3. The method of claim 1, wherein the deposit comprises the price of the goods, a shipping fee, and a service fee.

4. The method of claim 3, wherein at least one of said shipping fee and said service fee is transferred into a corporate account.

5. The method of claim 1, wherein the second individual registers an account on the server.

6. The method of claim 5, wherein transfer of the deposit to the second individual is an electronic transfer from the electronic bank to the second individual's account.

7. The method of claim 1, wherein the transfer of the deposit to the second individual is a money order.

8. The method of claim 1, wherein the first individual's account comprises at least the first individual's name, street address, e-mail address, phone number, security question, and password.

9. The method of claim 8, wherein the first individual's account further comprises the first individual's bank account information.

10. The method of claim 1, wherein the transaction information comprises at least the second individual's name, street address, e-mail address, phone number, and zip code.

11. The method of claim 10, wherein the transaction information further comprises an electronic image selected from the group consisting of a facial photo of the second individual and a photo of the purchased goods.

12. The method of claim 10, wherein the transaction information further comprises options fees, service fees, shipping fees, purchase price, and total charges.

13. A server comprising a computer readable medium having stored thereon computer executable instructions for implementing a method comprising:
a. registering an account of a first individual on a server and creating a transaction record with information associated with a transaction between the first individual and a second individual;
b. depositing funds in the first individual's account;
c. transferring the deposit from the first individual's account into an electronic bank;
d. approving the transaction record by both the first and second individuals;
e. presenting the second individual's goods to a shipping vendor;
f. entering a tracking number into the transaction record;
g. shipping the goods to the first individual using the shipping vendor; and
h. transferring the deposit from the electronic bank to the second individual.

14. The server of claim 17, wherein the first individual makes the deposit using a funds transfer system selected from the group consisting of a credit card, a bank account, a wire transfer, and cash.

15. The server of claim 17, wherein the deposit comprises the price of the goods, a shipping fee, and a service fee.

16. The server of claim 15, wherein at least one of the shipping fee and the service fee is transferred into a corporate account.

17. The server of claim 17, wherein the second individual registers an account on the server.

18. The server of claim 17, wherein transfer of the deposit to the second individual is an electronic transfer from the electronic bank to the second individual's account.

19. The server of claim 13, wherein the transfer of the deposit to the second individual is a money order.

20. The server of claim 13, wherein the first individual's account comprises at least the first individual's name, street address, e-mail address, phone number, security question, and password.

21. The server of claim 20, wherein the first individual's account further comprises the first individual's bank account information.

22. The server of claim 13, wherein the transaction information comprises at least the second individual's name, street address, e-mail address, phone number, and zip code.

23. The server of claim 13, wherein the transaction information further comprises an electronic image selected from the group consisting of a facial photo of the second individual and a photo of the purchased goods.

24. The server of claim 30, wherein the transaction information further comprises options fees, service fees, shipping fees, purchase price, and total charges.

25. A method for electronic payment and delivery of goods, the method comprising:
a. registering an account of a first individual on a server and creating a transaction record with information associated with a transaction between the first individual and a second individual;
b. depositing funds in the first individual's account;
c. presenting the second individual's goods to a shipping vendor;
d. shipping the goods to the first individual using the shipping vendor; and
e. transferring the deposit from the first individual's account to the second individual.
